(19) United States
(12) Patent Application Publication
(10) Pub. No.: US 2015/0254123 A1
(43) Pub. Date: Sep. 10, 2015

(54) Symmetric Multi-Processor Arrangement, Safety Critical System, And Method Therefor

(71) Applicant: ABB Technology Ltd, Zürich (CH)

(72) Inventors: Trond Loekstad, Nesoddtangen (NO); Frank Reichenbach, Regensburg (DE)

(21) Appl. No.: 14/432,938

(22) PCT Filed: Oct. 1, 2012
(86) PCT No.: PCT/EP2012/069355

§ 371 Date: Apr. 1, 2015

(51) Int. Cl. G06F 11/07; G06F 9/455

(52) U.S. Cl. CPC G06F 11/079; G06F 11/073; G06F 11/0721; G06F 9/45558; G06F 2009/45583; G06F 2009/45591

(57) ABSTRACT

A symmetric multi-core processor arrangement for a safety critical system, including: a symmetric multi-processor having at least two cores and a memory shared for the at least two cores; and a hypervisor connected to the symmetric multi-processor, and configured to organize access to the at least two cores for at least a diagnostic application checking the safety critical system; wherein, during use, the diagnostic application is configured to read from and write to the memory, and the hypervisor is configured to read only from the memory.

### TECHNICAL FIELD

The present invention generally relates to multi-processor arrangements and more particularly relates to diagnostics of symmetric multi-processor arrangements.

### BACKGROUND

For developing safety critical systems, such as robot systems, it is important to detect failures early enough and to switch the system into a so called safe state, where it cannot endanger humans or the environment. This means practically that both systematic errors, e.g. software/hardware design errors, must be avoided by proper verification and validation techniques in the process and random errors must be detected by e.g. proper diagnostic techniques or hardware redundancy. Proper verification and validation techniques for finding systematic errors are part of the development process for a safe critical system. Diagnostic techniques for finding random errors are executed periodically at runtime.

Diagnostics can be implemented in hardware (HW) and in software (SW). HW diagnostics are very costly but they can provide higher diagnostic coverage. One example for HW diagnostics is e.g. an ECC check module for RAM.

Diagnostics in SW are usually preferred, because they can be easily updated and customized. However, they can be slower than HW diagnostics and might not always reach all parts of the HW, such as special registers. They can be executed in parallel to application tasks, which lowers the overall system performance and could impact the safety functionality, i.e. a diagnostic function itself can fail and threaten the system safety.

On single processors diagnostics can be part, i.e. an own module/task, of the firmware. Some free processor time within the process cycle is usually used to check the system for safety integrity. The execution is completely serial. However, in near future most systems do no run on single processor arrangements, but run on multi-processor arrangements, which further complicate diagnostic techniques.

### SUMMARY

The way how diagnostics can work in multi-core systems must be completely reconceived, since the hardware is getting more and more sophisticated, the software configuration gets more and more complex and the dynamics needed on multi-processor units (MPUs) to fully utilize their potential will impact safety to a large extent.

Today safety critical systems for MPUs run mainly asymmetric multi-processing (AMP) assuming dedicating resources, like one core dedicated for the safety application. The core will not be available for other tasks, even if it is in idle mode. The performance of the system can thus never be optimal. The problem worsens if more cores are used. A failure in a dedicated safety core will lead to tripping into the safe state, even if there are other cores available that could keep the system alive. Further, a fixed voting scheme for redundancy control of e.g. a 1 out of 2 (1oo2) solution cannot be easily changed to a solution with more cores, such as a 2 out of 4 (2oo4) solution when the MPU increase power, i.e. is provided with more cores.

On MPUs the situation is different compared to single processor units, since a parallel execution should be utilized. A hypervisor software layer typically regulates access to shared resources and to core utilization. Symmetric multi-processing (SMP) is not yet accepted in safety critical systems due to too little control over health checks for shared resources and core utilization. SMP is however desirable also for safety critical systems, such that the hypervisor layer can be utilized to optimize hardware utilization. MPUs will get more and more cores and multithreading will be used to utilize the overall system resources. The complexity is increasing and the multi-core chip itself knows the optimal load distribution depending on performance vs. power consumption. A multi-core chip typically comprises cores, caches, a bus or switch matrix to connect to other components such as a memory, a memory protection unit, I/O:s, Ethernet cards etc.

Further, a static configuration wherein one safety application, also called partition, is dedicated to an own core is not flexible or scalable enough. A software developer should be able to abstract from the underlying hardware and focus on the application itself, even for safety critical implementation. The hypervisor shall distribute the workload optimized for maximum utilization of resources.

FIG. 1 illustrates a quad core system 1, where every application 2-5 is encapsulated in a virtual container with possibly its own operating system (OS), having access to all hardware multi-core resources 6-9. A hypervisor 10 will handle the optimal resource sharing. In this illustration a first application 2 is a safety application with diagnostics (including OS), a second application 3 is another safety application with diagnostics (including OS), a third application 4 is an arbitrary application (including OS) and a fourth application 5 is another arbitrary application (including OS). Examples of another arbitrary application are e.g. a control loop application or a human to machine interface (HMI) application. In this illustration the hardware has a first core 6, a second core 7, a third core 8 and a fourth core 9, all being identical cores of the multi-core processor hardware 1. The safety application 2 is e.g. executing on the first core 6 at time t=1, but at time t=2 it is executing on the second core 7, illustrated with arrows going from the safety application 2 to the first core 6 and the second core 7, respectively. Where the safety application 2 is presently executing is decided by the hypervisor 10, based on optimized load sharing. The hypervisor 10 will in this case let the third application 4 execute on the first core 6 at t=2, illustrated by an arrow from the third application 4 to the first core 6. The usage of resources will be highly dynamic allowing highest system performance, regulated by the hypervisor 10.

A typical safety solution on a multi-core processor hardware is here exemplified with a quad core processor with a redundancy of 1 out of 2 (1oo2).

A problem with safety critical applications, run on MPUs with SMP where resources are dynamically allocated over time, is that diagnostic tasks of safety critical applications are executed in free time slots between all other tasks. This is not efficient in a multithreaded environment.

An object of the present invention is to alleviate the above problem.

This object is according to the present invention attained by a symmetric to multi-core processor arrangement, and a method therefor, respectively, as defined by the appended claims.

By providing a symmetric multi-core processor arrangement for a safety critical system, comprising: a symmetric multi-processor having at least two cores and a memory shared for the at least two cores; and a hypervisor connected to the symmetric multi-processor, and configured to organize access to the at least two cores for at least a diagnostic application checking the safety critical system; wherein, during use, the diagnostic application is configured to read from and write to the memory, and the hypervisor is configured to read only from the memory, efficient diagnostic tasks are provided for a safety critical application run on a symmetric multi-processor arrangement.

For critical handling, the hypervisor is preferably configured to provide the diagnostic application with prioritized access to the multi-processor.

The safety critical system preferably comprises at least two diagnostic applications during use for diagnostic redundancy also regarding software.

A safety critical system, such as a robot, is also provided.

By providing a method for a diagnostic check of a safety critical system, such as a robot, comprising the following steps: writing to and reading from a memory shared by at least two cores of a symmetric multi-processor through a diagnostic application of the safety critical system; and organizing access to the at least two cores of the symmetric multi-processor for the safety critical system through a hypervisor, and the hypervisor being configured for reading only from the memory shared by the at least two cores; wherein the diagnostic application is configured to check status of one or more resources of the safety critical system, efficient diagnostic tasks are provided for a safety critical application run on a symmetric multi-processor arrangement.

For efficient utilization of the shared memory, the method preferably comprises the step of updating a health status indicator in the memory for each resource the diagnostic application is monitoring through the diagnostic application. Advantageously, the health status indicator comprises, for each resource being monitored: status of a diagnostic test being executed, a timed stamp when run, and time since last check.

For critical handling, the diagnostic application preferably has prioritized access to the multi-processor, utilized when a monitored resource continuously is used by another application of the safety critical system.

The method preferably comprises the step of reconfiguring a voting scheme for the diagnostic application dynamically, to allow e.g. runtime reconfiguration.

A computer program product is also provided.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates a known symmetric multi-processor arrangement.

FIG. 2 illustrates a symmetric multi-processor arrangement according to a first embodiment of the present invention.

FIG. 3 illustrates a symmetric multi-processor arrangement according to a second embodiment of the present invention.

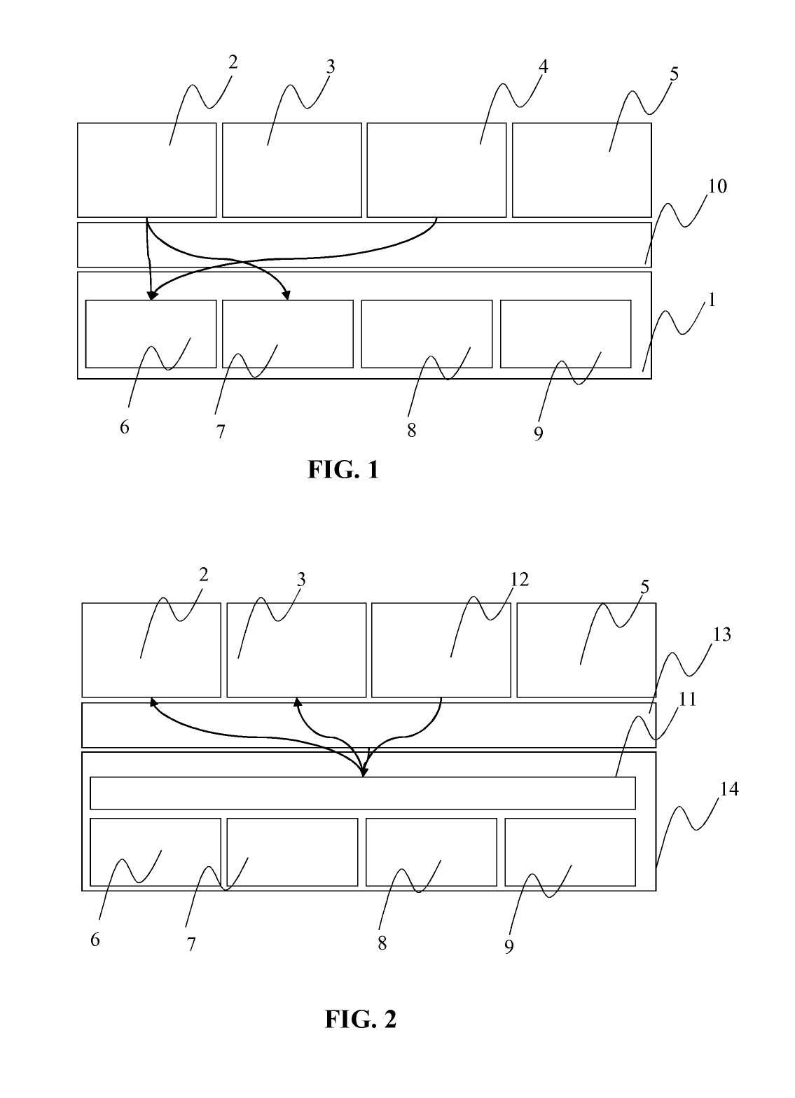

### DETAILED DESCRIPTION

to The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

A first embodiment of a multi-core processor arrangement, which executes among other functions diagnostic functions, according to the present invention will now, by way of example, be described in greater detail with reference to FIG. 2.

The symmetric multi-core processor arrangement is suitable for use in a safety critical system and comprises: a symmetric multi-processor 14 having at least two cores 6-9 and a memory 11 shared for the at least two cores 6-9; and a hypervisor 13 connected to the symmetric multi-processor 14, and configured to organize access to the at least two cores 6-9 for at least a diagnostic application 12 checking/diagnosing the safety critical system. During use, the diagnostic application 12 is configured to read from and write to the shared memory 11, and the hypervisor 13 is configured to read only from the shared memory 11.

The safety critical system, particularly an industrial robot, is equipped with a health check module for the multi-core processor arrangement which executes among other things diagnostic functions that can be run fully dynamic to check the health state of all safety critical components of the safety critical system. The health check module provides the actual health status of the safety critical system and contributes to high safety and availability in industrial safety systems.

In this first embodiment of the present invention a first application 2 is a safety application including OS, and the second application 3 is also a safety application including OS. The third application 12 is a health check module with diagnostics including OS, and the fourth application 5 is another application including OS. The symmetric multi-processor 14 has a first core 6, a second core 7, a third core 8, and a fourth core 9, all being identical cores and sharing the same built-in memory 11.

Both safe and non-safe applications will run on the same system, but fully separated, so that safety functionality is not compromised. Only the health check module 12 has write access to the memory 11. According to safety standards like IEC 61508 it has to be proven that non-safe applications cannot impact safety functions in a way so that the safety functionality is hindered to execute properly. This can be achieved by separation in space (e.g. separated memory for safe and non-safe applications) or separation in time (e.g. safe data are send as a package over a bus and then afterwards non-safe data are send over the same bus).

To keep the safety critical system from tripping unnecessarily, the hypervisor 13 is preferably configured to provide the diagnostic application 12 of the health check module with prioritized access to the multi-processor arrangement 14. In case the safety critical system e.g. cannot diagnose a component/resource it is monitoring within a pre-set period of time, the safety critical system will trip. However, with a possibility for the health check module to utilize prioritized access to a resource of the safety critical system, the health check module will be able to override other applications executing and the likelihood for unnecessary tripping of the safety critical system is reduced. Advantageously, the health check module only utilizes its prioritized access when necessary to not trip the system.

When e.g. a soft error has occurred, such as if an electron hits the bus and a message gets corrupted, and the system has detected this error which it reports to the health check module, the health check module does not trip to to safe state immediately and instead does further error investigation by running a small bus check, which in this case typically replies “no error in bus found”. The health check module thus assumes a soft error instead of a permanent error and requests the safe core to resend the same message. This is done by the core and the same error does not happen, so the system can move on with the safe function without tripping the system into safe state.

The method to check the safety critical system, typically being a robot, comprises the following steps: writing to and reading from the memory 11 shared by the four cores 6-9 of the symmetric multi-processor 14 through the diagnostic application 12 of the safety critical system; and organizing access to the four cores of the symmetric multi-processor 14, for all applications/resources utilizing the safety critical system, through the hypervisor 13, and the hypervisor 13 being configured for reading only from the memory 11 shared by the four cores. The diagnostic application 12 is configured to check status of one or more resources of the safety critical system, such as RAM, flash, bus, core etc.

The diagnostic application 12 is a software that checks hardware at runtime as a background task, which thus will not decrease system performance.

The diagnostic software, further bundled in the so called health check module (HCM), will run as an own application in the safety critical system, so that it can access all the resources as any other application on the MPU as shown in the FIG. 2. Moreover, the HCM has access to the shared memory 11 to inform other applications about the system health state. This shared memory is in read/write mode for the HCM and in read mode only for all other applications, so that they cannot change the data. Above all the hypervisor needs read access to this, but also a safety application could access it for their purpose.

The health check module 12 is preferably configured to update a health status indicator in the memory 11 for each resource it is monitoring through the diagnostic application.

The health status indicator (HSI) preferably comprises, for each resource being monitored: status of a diagnostic test being executed, a timed stamp when run, and time since last check. The health status indicator may further comprise usage, estimated mean time to failure (MTTF), criticality, etc., which is illustrated in table 1 below.

For each resource, i.e. RAM, Flash, bus, core, etc., of the safe critical system the HCM will create a HSI value indicating the safety integrity of each component/resource. The HSI value is including the status of the diagnostic tests being executed, the time stamp when run, and other factors as the usage of the component (affecting the Mean Time to Failure and likelihood of soft or transient errors). A way to determine a HSI value could e.g. be from a table quantifying each value as e.g. criticality high as 1, medium as 2 and so on as well as for the others diagnostic status <33%=1, >33% and <66%=2, >66%=3. All values can then be multiply together and a high value is good health while a small value is bad health.

TABLE 1
Shared table for the health check module maintaining
health state for each component/resource monitored
through the diagnostic application

| | | | Diag- | | Esti- | | |
|---|---|---|---|---|---|---|---|
| Compo- | HSI | Time Since | nostic | | mated | Criti- | |
| nent | Value | Last Check | Status | Usage | MTTF | cality | Etc. |
| RAM | XY | 30 seconds | 100% | 23% | 9324 | High | . . . |
| | | ago | ok | | days | | |
| CPU 1 | . . . | . . . | . . . | . . . | . . . | . . . | . . . |
| CPU 2 | . . . | . . . | . . . | . . . | . . . | . . . | . . . |
| . . . | . . . | . . . | . . . | . . . | . . . | . . . | . . . |

The hypervisor will use the HSI value to organize shared access for the safety critical components. It will always use components with the best HSI values (XY) to provide maximum safety. If a component/resource has a low HSI value the usage for safety critical functionality could be disabled, and only used by non-safety applications. An example of how to determine a trigger level for disabling a component for safety critical utilisation may use the calculation from above, covert it into percentage (the number of values are known and that they are between 1 and 3), then a component is disabled to under 33%, the component is rechecked when between 33 and 66% and left without action when above 66%. This will increase availability by reducing trip to safe state actions. The health check module may also include a voting scheme, so that it can start or stop partitions/cores to e.g. switch between high safety, such as 1oo2, or high availability, such as 2oo3.

A safety application will, by the safety critical system being diagnosed by the health check module, to a greater extend be executed on a reliable HW, where the safest, i.e. best HIS, components are used. This will improve both safety and availability for the safety critical system. A fault tolerance is provided in that the safety application can switch to a healthy core, even if one or more cores are malfunctioning and have to be disabled by the health check module.

A typical voting scheme for the health check module, in a multi-processing arrangement having four cores, is 1oo2. The health check module then relies on the result of diagnostics run on two different cores, as long as they provide reasonably the same result. The health check module is preferably reconfigurable dynamically for changing the voting scheme to e.g. 1oo3 or 2oo4, which may be desired if the multi-processing arrangement dynamically is reconfigured to have e.g. sixteen cores, or to change between high safety and high availability for the safety critical system during runtime.

The health check module will keep the HIS table updated with the latest to system state—health state. Thus can e.g. Mean Time to Failure estimations be done and the system can be replaced at a Proof Test Interval before tripping.

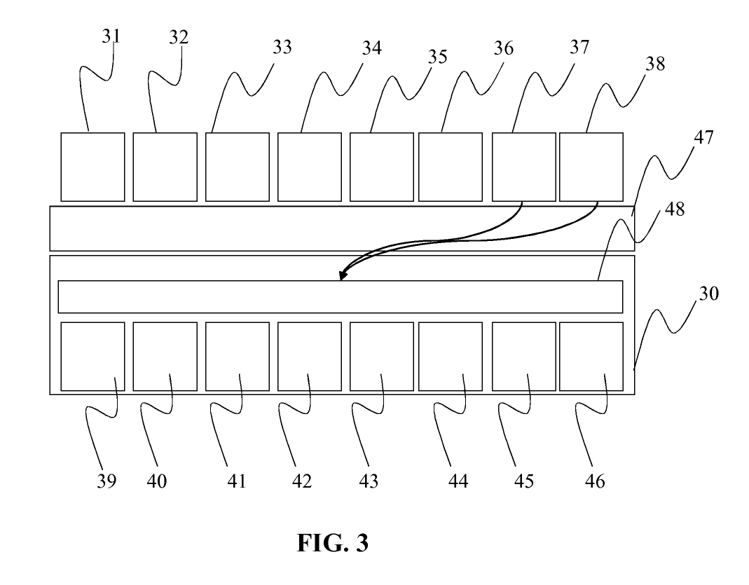

A second embodiment of a multi-core processor arrangement, which executes, among other functions, diagnostic functions according to the present invention will now, by way of example, be described in greater detail with reference to FIG. 3. This second embodiment of the present invention is identical to the first embodiment described above, apart from the following.

In this second embodiment of the present invention a first application 31 is a safety application including OS, and a second application 32 is also a safety application including OS. A third application 33 to a sixth application 36, are other applications including OS. The seventh application 37, as well as the eighth application 38, are both health check modules with diagnostics including OS. The symmetric multi-processor 30 has a first core 39 to an eighth core 46, all being identical cores sharing the same built-in memory 48.

The safety critical system comprises at least two diagnostic applications 37, 38 during use for diagnostic redundancy also of software. Thus, both the first and the second diagnostic applications 37 and 38 are configured to write to and read from the shared memory 48, wherein all other applications are configured to read only from the shared memory 48, particularly the hypervisor 47. Writing to the memory 48, shared by all cores, is illustrated by arrows in FIG. 3

The HCM thus run in a second partition as a backup if the first HCM is corrupted. Moreover parallelism may even be used to speed up the diagnostic check.

Execution of the applications described above in the first and second embodiments of the present invention is typically performed by a computer program storable on a computer program product.

The invention has mainly been described above with reference to a few examples. However, as is readily appreciated by a person skilled in the art, other embodiments than the ones disclosed above are equally possible within the scope of the present invention, as defined by the appended claims.

1. A symmetric multi-core processor arrangement for a safety critical system, comprising:
a symmetric multi-processor having at least two cores and a memory shared for said at least two cores; and
a hypervisor connected to said symmetric multi-processor, and configured to organize access to said at least two cores for at least a diagnostic application checking said safety critical system;
wherein, during use, said diagnostic application is configured to read from and write to said memory, and said hypervisor is configured to read only from said memory.

2. The symmetric multi-processor arrangement according to claim 1, wherein said hypervisor is configured to provide said diagnostic application with prioritized access to said multi-processor.

3. The symmetric multi-processor arrangement according to claim 1, wherein said safety critical system comprises at least two diagnostic applications during use for diagnostic redundancy.

4. A safety critical system, such as a robot, comprising the symmetric multi-processor arrangement according to claim 1.

5. A method for a diagnostic check of a safety critical system, such as a robot, comprising the following steps:
writing to and reading from a memory shared by at least two cores of a symmetric multi-processor through a diagnostic application of said safety critical system; and
organizing access to said at least two cores of the symmetric multi-processor for said safety critical system through a hypervisor, and said hypervisor being configured for reading only from said memory shared by said at least two cores;
wherein said diagnostic application is configured to check status of one or more resources of said safety critical system.

6. The method according to claim 5, comprising the step of:
updating a health status indicator in said memory for each resource said diagnostic application is monitoring through said diagnostic application.

7. The method according to claim 6, wherein said health status indicator comprises, for each resource being monitored: status of a diagnostic test being executed, a timed stamp when run, and time since last check.

8. The method according to claim 5, wherein said diagnostic application has prioritized access to said multi-processor, utilized when a monitored resource continuously is used by another application of said safety critical system.

9. The method according to claim 5, comprising the step of:
reconfiguring a voting scheme for said diagnostic application dynamically.

10. The method according to claim 5, comprising the step of:
writing to and reading from said memory through a second diagnostic application of said safety critical system.

11. A computer program product comprising a computer program for performing a method for a diagnostic check of a safety critical system, such as a robot, comprising the following steps:
writing to and reading from a memory shared by at least two cores of a symmetric multi-processor through a diagnostic application of said safety critical system; and
organizing access to said at least two cores of the symmetric multi-processor for said safety critical system through a hypervisor, and said hypervisor being configured for reading only from said memory shared by said at least two cores;
wherein said diagnostic application is configured to check status of one or more resources of said safety critical system.
